(19) United States
(12) Patent Application Publication
(10) Pub. No.: US 2007/0260021 A1
(43) Pub. Date: Nov. 8, 2007

(54) Soft-Modified Polyvinyl Acetal Resins

(75) Inventor: Andreas Lumpp, Sao Paulo, S.P. (BR)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 11/570,145

(22) PCT Filed: Jun. 23, 2005
(86) PCT No.: PCT/EP05/06819

§ 371 Date: Dec. 7, 2006

(30) Foreign Application Priority Data
Jul. 1, 2004 (DE) 10 2004 031 969.3

(51) Int. Cl. C08F 2/06

(52) U.S. Cl. 525/451

(57) ABSTRACT

Softness-modified polyvinyl acetal resins are obtained via hydrolyzing copolymers of vinyl acetate and C₉₋₁₅ monocarboxylic acids, which contain from 5 to 60% by weight of tertiary vinyl ester, and subsequently acetalizing with one or more C₁₋₆ aliphatic aldehydes.

The invention relates to softness-modified polyvinyl acetal resins, to a process for their preparation, and to their use.

The preparation of polyvinyl acetals from the corresponding polyvinyl alcohols via polymer-analogous reaction with the appropriate aldehydes has been known since 1924, and in the intervening period a wide variety of aldehydes has been used to prepare the corresponding polyvinyl acetals. Polyvinyl acetals are prepared in a 3-stage process (polyvinyl acetate→polyvinyl alcohol→polyvinyl acetal), giving products which still contain vinyl alcohol units and vinyl acetate units, alongside vinyl acetal groups. Modified polyvinyl acetals hereinafter mean those which contain other units alongside the three units mentioned. Polyvinyl formal, polyvinyl acetal and polyvinyl butyral have achieved particular commercial importance.

In certain applications of polyvinyl acetal resins there is a requirement for these to be softened, for example for use as a foil in safety glass. In this connection, the prior art discloses treatment of polyvinyl butyral with plasticizers, e.g. triethylene glycol di-n-heptanoate, phthalic esters of alcohols having from 6 to 10 carbon atoms, tri(2-ethylhexyl)phosphate and tricresyl phosphate. The plasticizers sometimes have only limited miscibility with the acetals, and the plasticizers sometimes sublime with ageing and thus lose their plasticizing action, and sometimes the plasticizers are extracted on contact with solvent. In all instances, changes in properties can be observed. EP-A 394884 describes internal plasticization by means of acetalization with oxyethylene aldehydes. A disadvantage here is that the polyvinyl acetal becomes less hydrophobic.

It was therefore an object to provide softness-modified polyvinyl acetal resin without the necessity to admix additives, such as plasticizers, with the polyvinyl acetal.

The invention provides softness-modified polyvinyl acetal resins obtainable via hydrolysis of copolymers composed of vinyl acetate and of one or more tertiary vinyl esters of alpha-branched monocarboxylic acids having from 9 to 15 carbon atoms, which contain, based on the total weight of the copolymer, from 5 to 60% by weight of tertiary vinyl ester, and subsequent acetalization, with one or more aliphatic aldehydes having from 1 to 6 carbon atoms, of the hydrolysis products having vinyl alcohol units.

Preferred tertiary vinyl esters of alpha-branched monocarboxylic acids having from 9 to 15 carbon atoms are those having from 9 to 11 carbon atoms, such as VeoVa9®, VeoVa10® and VeoVa11® (trade names of Resolution Performance Products). Particular preference is given to tertiary vinyl esters of alpha-branched monocarboxylic acids having 10 carbon atoms, such as VeoVa10®. The copolymers of vinyl acetate and tertiary vinyl ester preferably contain from 30% to 50% by weight of tertiary vinyl ester, based on the total weight of the copolymer.

Examples of suitable aliphatic aldehydes having from 1 to 6 carbon atoms are formaldehyde, acetaldehyde, propionaldehyde and butyraldehyde. Preference is given to acetaldehyde and butyraldehyde and their mixtures.

The softness-modified polyvinyl acetals preferably comprise

a) from 20 to 70% by weight of vinyl acetal units,

b) from 5 to 30% by weight of vinyl alcohol units,

c) from 5 to 60% by weight of tert. vinyl ester units, and

d) from 0.5 to 10% by weight of vinyl acetate units, where in each case the % by weight data give a total of 100% by weight.

Most preference is given to polyvinyl acetals which comprise from 40 to 60% by weight of vinyl acetal units a), from 10 to 25% by weight of vinyl alcohol units b), from 30 to 50% by weight of tert. vinyl ester units c), and from 1 to 5% by weight of vinyl acetate units d).

The polyvinyl acetals may, if appropriate, also contain from 1 to 5% by weight of other monomer units. Examples here are carboxy-functional comonomers, such as acrylic acid, methacrylic acid, crotonic acid, and amide-functional comonomers, such as acrylamide, methacrylamide.

The invention also provides a process for preparation of softness-modified polyvinyl acetals via hydrolysis of copolymers composed of vinyl acetate and of one or more tertiary vinyl esters of alpha-branched monocarboxylic acids having from 9 to 15 carbon atoms, which contain, from 5 to 60% by weight of tertiary vinyl ester, and subsequent acetalization, with one or more aliphatic aldehydes having from 1 to 6 carbon atoms, of the hydrolysis products having vinyl alcohol units, with acid catalysis in an aqueous and/or organic medium.

To prepare the softness-modified polyvinyl acetals, vinyl acetate and the tertiary vinyl ester content are copolymerized in a first step. From 1 to 5% by weight, based on the total weight of the comonomers, of other monomers may also be copolymerized if appropriate, examples being comonomers containing carboxy groups and/or containing amide groups.

The polymerization process takes place in a known manner, via suspension polymerization, or preferably via bulk polymerization or via polymerization in organic solvents, particularly preferably in alcoholic solution. Examples of suitable solvents and regulators are methanol, ethanol, propanol, isopropanol. The polymerization process is carried out at reflux at a temperature of 60° C. to 100° C. and is initiated by a free-radical mechanism, via addition of familiar initiators. Examples of familiar initiators are percarbonates, such as cyclohexyl peroxydicarbonate. The molecular weight may be adjusted in a known manner via addition of regulator, via the solvent content, via variation of the initiator concentration and via variation of the temperature. The molecular weight (weight-average Mw) set is preferably from 5000 to 100 000. Once the polymerization has ended, the solvent is removed by distillation, as also, if appropriate, are excess monomer and regulator.

The hydrolysis of the vinyl acetate units takes place in a manner known per se, for example by the belt process or kneader process, under alkaline or acidic conditions, with addition of acid or base. The tert. vinyl ester-vinyl acetate copolymer is preferably taken up in alcohol, such as methanol, to give a solids content of from 30 to 70% by weight. The hydrolysis process is preferably carried out under basic conditions, for example via addition of NaOH, KOH or NaOCH₃. The amount generally added of the base is from 1 to 5 mol % per mole of acetate units. The hydrolysis process is carried out at temperatures of from 30° C. to 60° C. Once the hydrolysis process has ended, the solvent is, if appropriate, removed by distillation.

The residual vinyl ester content of the hydrolyzed copolymers is preferably from 5 to 70% by weight, based on the total weight of the copolymer.

For acetalization, the hydrolyzed tert. vinyl ester-vinyl acetate copolymers are preferably taken up in an aqueous medium. The resultant solids content of the aqueous solution is usually from 5 to 30% by weight. The acetalization process takes place in the presence of acidic catalysts, such as hydrochloric acid, sulphuric acid or phosphoric acid. The pH of the solution is preferably adjusted to values <1 via addition of 20% strength hydrochloric acid.

After addition of the catalyst, the solution is cooled, preferably to from −10° C. to +30° C., and the acetalization reaction is initiated via addition of the aldehyde. The amount added depends here on the desired degree of acetalization. Because the acetalization process proceeds with almost complete conversion, the amount added can be determined via simple stoichiometric calculation. Once addition of the aldehyde has ended, the acetalization process is completed via heating of the mixture to from 20° C. to 60° C. and stirring for a number of hours, preferably from 1 to 6 hours, and the pulverulent reaction product is isolated via filtration.

The inventive procedure can give polyvinyl acetals which have a markedly lower glass transition temperature Tg without addition of plasticizer.

The softness-modified polyvinyl butyrals are used as a foil in safety glass and as an acoustic foil, as binder in printing inks, as binder in primers, as binder in corrosion-protection compositions, as binder in the ceramics industry, specifically as binder for ceramic articles prior to final firing. Another use which may be mentioned is that as binder for ceramic powders and metal powders in injection moulding (powder injection moulding), as binder for glass fibre, and as binder for the internal coating of cans, if appropriate in combination with crosslinking agents, such as epoxy resins.

The inventive examples below provide further illustration of the invention:

### INVENTIVE EXAMPLE 1

200 g of a copolymer composed of vinyl acetate and VeoVa10® (ratio by weight 70/30) were dissolved in 900 g of methanol at 60° C. in a 4 l reactor with reflux condenser, feed equipment, and an anchor stirrer. Once all of the material had dissolved, 8 ml of a 45% strength methanolic NaOH solution were fed. After 2 hours, conc. acetic acid was used to adjust the pH to about 7.

100 g of butyraldehyde were then metered in within the same reaction vessel. After addition of 167 g of a 15% strength methanolic sulphuric acid solution, the mixture was refluxed for a further 2 hours and neutralized by means of addition of a 10% strength NaOH solution. The mixture composed of solvent and butyraldehyde is removed by distillation. The almost solidified melt was dissolved in ethanol (with an option that methanol can also be used) to give a solids content of 10%. The precipitation step followed. The precipitation temperature was −1° C. initially, and was lowered to −5° C. during the precipitation process. For this purpose, about 600 ml of the 10% strength solution were added dropwise into 4 l of a KHCO₃ solution (0.2% strength, pH=8.5). The product was suction-filtered and dried.

This gave a polyvinyl butyral having 52% by weight of vinyl butyral units, 32% by weight of VeoVa10 units, 15% by weight of vinyl alcohol units, and 1% by weight of vinyl acetate units. The glass transition temperature Tg was 46° C.

### INVENTIVE EXAMPLE 2

The procedure was analogous to that of inventive example 1, except that 200 g of a copolymer composed of vinyl acetate and VeoVa10® (ratio by weight 50/50) were used as starting material.

This gave a polyvinyl butyral having 32% by weight of vinyl butyral units, 57% by weight of VeoVa10 units, 10% by weight of vinyl alcohol units, and 1% by weight of vinyl acetate units. The glass transition temperature Tg was 31° C.

### INVENTIVE EXAMPLE 3

The procedure was analogous to that of inventive example 1, except that 200 g of a copolymer composed of vinyl acetate and VeoVa9® (ratio by weight 50/50) were used as starting material.

This gave a polyvinyl butyral having 30% by weight of vinyl butyral units, 53% by weight of VeoVa9 units, 16% by weight of vinyl alcohol units, and 1% by weight of vinyl acetate units. The glass transition temperature Tg was 61° C.

### INVENTIVE EXAMPLE 4

The procedure was analogous to that of inventive example 1, except that 200 g of a copolymer composed of vinyl acetate and VeoVa9® (ratio by weight 30/70) were used as starting material.

This gave a polyvinyl butyral having 47% by weight of vinyl butyral units, 36% by weight of VeoVa9 units, 16% by weight of vinyl alcohol units, and 1% by weight of vinyl acetate units. The glass transition temperature Tg was 65° C.

### COMPARATIVE EXAMPLE 5

Commercially available polyvinyl butyral (Pioloform BR18) having 80% by weight of vinyl butyral units, 18% by weight of vinyl alcohol units and 2% by weight of vinyl acetate units. The glass transition temperature Tg is 71° C.

1-12. (canceled)

13. Softness-modified polyvinyl acetal resins prepared by hydrolyzing copolymers comprising vinyl acetate and one or more tertiary vinyl esters of alpha-branched C₉₋₁₅ monocarboxylic acids and which contain, based on the total weight of the monomers, from 5 to 60% by weight of tertiary vinyl ester, and subsequently acetalizing the hydrolysis products having vinyl alcohol units with one or more aliphatic C₁₋₆ aldehydes.

14. A softness-modified polyvinyl acetal resin of claim 13, wherein the tertiary vinyl esters are esters of alpha-branched monocarboxylic acids having from 9 to 11 carbon atoms.

15. A softness-modified polyvinyl acetal resin of claim 13, wherein acetaldehyde, butyraldehyde or a mixture thereof is employed as the aldehyde.

16. A softness-modified polyvinyl acetal resin of claim 13, comprising
a) from 20 to 70% by weight of vinyl acetal units,
b) from 5 to 30% by weight of vinyl alcohol units,
c) from 5 to 60% by weight of tertiary vinyl ester units, and
d) from 0.5 to 10% by weight of vinyl acetate units,
where the % by weight totals 100% by weight.

17. A softness-modified polyvinyl acetal resin of claim 13, wherein based on the total weight of the comonomers, from 1 to 5% by weight of carboxy-containing comonomers, amide-containing comonomers, or a mixture thereof are copolymerized.

18. A process for the preparation of the softness-modified polyvinyl acetals of claim 13, comprising hydrolyzing copolymers prepared by copolymerizing vinyl acetate and at least one tertiary vinyl ester of alpha-branched C₉₋₁₅ monocarboxylic acids, and which contain, from 5 to 60% by weight of tertiary vinyl ester-derived units, and subsequently acetalizing the hydrolysis products having vinyl alcohol units with one or more C₁₋₆ aliphatic aldehydes with acid catalysis in an aqueous medium, an organic medium, or an aqueous organic medium.

19. In a film for safety glass or acoustic film where a polyvinylacetal is employed, the improvement comprising preparing said film with at least one softness-modified polyvinyl alcohol of claim 13.

20. In a binder composition employing a polyvinyl acetal, the improvement comprising selecting as at least one polyvinyl acetal, a softness-modified polyvinyl acetal of claim 13.

21. The binder composition of claim 20 which is a binder for a product selected from the group consisting of printing ink, primer, corrosion-protectant, ceramics, injection moldable ceramic powder, injection moldable metal powder, glass fibers, and can coatings.
